(19) United States
(12) Patent Application Publication
(10) Pub. No.: US 2020/0240466 A1
(43) Pub. Date: Jul. 30, 2020

(54) Multirow Ball Bearing and Manufacturing Method Therefor

(71) Applicant: NITTAN VALVE CO., LTD., Hadano-shi Kanagawa (JP)

(72) Inventor: Michihiro KAMEDA, Ota-shi Gunma (JP)

(21) Appl. No.: 16/851,141

(22) Filed: Apr. 17, 2020

Related U.S. Application Data
(63) Continuation-in-part of application No. PCT/JP2017/037450, filed on Oct. 17, 2017.

(51) Int. Cl. F16C 19/18; F16C 19/50; F16C 33/58

(52) U.S. Cl. CPC F16C 19/18; F16C 33/585; F16C 19/505

(57) ABSTRACT

Embodiments of the present invention may provide a multirow ball bearing capable of effectively dispersing a radial load while reducing a frictional force when an inner ring and an outer ring rotate relative to each other, and a method of manufacturing same. Multiple ball rows (5) may be adjacently interposed between an inner ring (3) and an outer ring (4); each of the multiple ball rows (5) may include balls (5a) arranged with prescribed gaps (L) therebetween and may be arranged in staggered fashion so as to be shifted in a row direction of the ball row (5) relative to a ball row (5) adjacent to the ball row (5), and the balls (5a) in each of the ball rows (5) may face spaces (LS) formed by the prescribed gaps (L) in a ball row (5) adjacent to the ball row (5), each of the balls being brought into contact with two of the balls (5a) that define one of the prescribed gaps.

### INCORPORATION BY REFERENCE

This application is a continuation-in-part of and claims benefit under 35 USC 120 and 365(c) to copending International Application No. PCT/JP2017/037450, entitled “Multi-Row Ball Bearing and Manufacturing Method Therefor”, filed 17 Oct. 2017, the content of which is incorporated herein in its entirety by reference.

### FIELD OF THE INVENTION

The present invention relates to a multirow ball bearing including multiple ball rows interposed between an inner ring and an outer ring, and a method of manufacturing same.

### BACKGROUND

One type of multirow ball bearing may include multiple ball rows interposed between an inner ring and an outer ring, the outer ring being disposed on an outer circumferential side of the inner ring, such that the ball rows are adjacent to each other in an axial direction of the inner ring and the outer ring, and a support shaft such as a rotary shaft is attached to the inner ring of the multirow ball bearing.

In such a multirow ball bearing, balls of multiple ball rows (for supporting a radial load) may be arranged with prescribed gaps therebetween, and each of the ball rows may be arranged in staggered fashion so as to be shifted in a row direction of the ball row relative to a ball row adjacent thereto so as to allow the balls of each of the ball rows to face spaces formed by the prescribed gaps in a ball row adjacent to the ball row, and to enable the balls to roll and move in an axial direction (axial direction of the inner ring and the outer ring).

Such a bearing may make it possible for a radial load (radial inward load) acting on the outer ring to be dispersed by the multiple balls of the multiple ball rows, and in embodiments in which adjacent balls are not in contact with each other, may also make it possible for frictional forces to be greatly reduced during relative rotation between the inner ring and the outer ring.

But with such a multirow ball bearing, it is sometimes the case that the balls of the multiple ball rows are able to freely roll and move in the axial direction. Where this is the case, a radial load acting on the outer ring may cause occurrence of a situation in which the radial load is borne in less than uniform fashion due to the free rolling movement of the balls. Where this is the case, a radial load acting on the outer ring may cause occurrence of a situation in which the radial load cannot be effectively dispersed, thus preventing the merits of the multirow arrangement from being sufficiently reflected in terms of increase in basic dynamic load rating and longer operating life.

The present invention was conceived in light of such situations, it being a first object thereof to provide a multirow ball bearing capable of effectively dispersing a radial load while reducing the frictional force produced when an inner ring and an outer ring rotate relative to each other.

A second object is to provide a multirow ball bearing manufacturing method for manufacturing such a multirow ball bearing.

### SUMMARY OF INVENTION

In accordance with at least one embodiment of the present invention, a multirow ball bearing may define a bearing axial direction, a bearing radial direction, and a bearing circumferential direction.

The multirow ball bearing may further define a bearing width direction parallel to the bearing axial direction and demarcating two ends in the axial direction of the multirow ball bearing.

In some embodiments, the multirow ball bearing may comprise an inner ring.

The multirow ball bearing may further comprise an outer ring arranged toward an exterior in the radial direction from the inner ring.

In some embodiments, the multirow ball bearing may further comprise first and second rows of balls interposed between the inner ring and the outer ring. The first and second rows may be respectively arranged in outwardmost fashion at either of the ends in the bearing width direction of the multirow ball bearing.

In some embodiments, the multirow ball bearing may further comprise at least one third row of balls interposed between the inner ring and the outer ring. The at least one third row may be arranged so as to be inward in the bearing width direction from the first and second rows.

The balls in each of the rows may be arranged with gaps therebetween in the circumferential direction.

The rows of balls include at least one pair of rows that are mutually adjacent in the bearing width direction. The mutually adjacent rows may be arranged in staggered fashion such that a first ball in a first of the pair of mutually adjacent rows is brought into contact with a second ball and a third ball in a second of the pair of mutually adjacent rows so that the first ball faces a first space formed by a first gap which, among the gaps between the balls arranged in the circumferential direction, is formed between the second ball and the third ball.

In some embodiments, the total number of rows of balls in the multirow ball bearing is an even number not less than four. In other embodiments, the total number of rows of balls in the multirow ball bearing is an odd number not less than three.

Diameters of balls in a first next-to-outwardmost row of balls among the at least one third row of balls and adjacent to the first row of balls may be less than diameters of balls in the first row of balls.

Elastic modulus of the balls in a first next-to-outwardmost row of balls among the at least one third row of balls and adjacent to the first row of balls may be less than elastic modulus of the balls in the first row of balls.

A first contact resistance of a fourth ball in a first next-to-outwardmost row of balls among the at least one third row of balls and adjacent to the first row of balls with respect to a fifth ball in the first row of balls may be different from a second contact resistance of a sixth ball in a second next-to-outwardmost row of balls among the at least one third row of balls and adjacent to the second row of balls with respect to a seventh ball in the second row of balls. But note that the first and the second next-to-outwardmost rows of balls may be the same row of balls when the total number of rows of balls is three.

To achieve the first object, configurations such as (1) to (8) may be employed in accordance with embodiments of the present invention.

(1) In a multirow ball bearing including multiple ball rows interposed between an inner ring and an outer ring, the outer ring being disposed on an outer circumferential side of the inner ring, such that the ball rows are adjacent to each other in an axial direction of the inner ring and the outer ring,

each of the multiple ball rows includes balls arranged with prescribed gaps therebetween in the ball row and is arranged in staggered fashion so as to be shifted in a row direction of the ball row relative to a ball row adjacent to the ball row, and

the balls in each of the ball rows face spaces formed by the prescribed gaps in a ball row adjacent to the ball row, each of the balls being brought into contact with two of the balls that define one of the prescribed gaps.

According to this configuration, each of the balls of each of the ball rows is brought into contact with the balls arranged adjacently in the row direction in a ball row adjacent to the ball row so that the balls do not individually freely roll and move (the balls integrally revolve while rotating about their own axes when the inner and outer rings relatively rotate), and even if a radial load (radial inward load) acts on the outer ring, the radial load acting on the outer ring can be borne in approximately uniform fashion. Therefore, the radial load acting on the outer ring can be effectively dispersed.

On the other hand, the balls in the ball rows integrally revolve while rotating about their own axes at the time of relative rotation between the inner ring and the outer ring, the rotation of each ball about its own axis has a rotation component based on the revolution of the ball rows added to a basic rotation component based on the relative rotation between the inner ring and the outer ring (the rotation component in the direction opposite to the revolution direction), so that the balls of the adjacent ball rows each rotate in contact with each other under a symmetrically inclined combined axis. Therefore, the balls in contact with each other move (rotate) toward substantially the same side at the contact portion therebetween although not exactly in the same direction, so that the frictional force can be reduced as compared to when the movement directions of the contacting balls are opposite to each other at the contact portion.

This enables provision of a multirow ball bearing capable of effectively dispersing a radial load acting on the outer ring while reducing as much as possible the frictional force produced during relative rotation between the inner ring and the outer ring.

Additionally, to the extent that collisions between the balls due to the rolling movement of the balls can be eliminated, it will be possible in such case to prevent the balls from being damaged and from generating noise due to the collisions that would otherwise occur.

(2) In the context of the configuration of (1), it may additionally be the case that

there is an even number not less than four of the multiple ball rows, and

the multiple ball rows are such that during relative rotation between the inner ring and the outer ring, a revolution driving force of the outermost ball rows becomes relatively larger than a revolution driving force of the inner ball rows adjacent to the outermost ball rows.

According to this configuration, the balls of the ball rows not only can stably obtain a rotation component based on a revolution driving force difference of the ball rows, but also can cause a combined axis formed by the rotation component based on the revolution driving force difference of the ball rows and a basic rotation component based on the relative rotation between the inner ring and the outer ring to rapidly attain a state of an optimum combined axis so as to make the multirow ball bearing preferable in terms of reduction in initial rotation resistance (frictional resistance).

(3) In the context of the configuration of (1), it may additionally be the case that

there is an odd number not less than three of the multiple ball rows, and

the multiple ball rows are preferably such that a contact resistance of balls at an inner ball row adjacent to a first outermost ball row with respect to balls in the first outermost ball row is different from a contact resistance of balls at an inner ball row adjacent to a second outermost ball row with respect to balls in the second outermost ball row.

According to this configuration, the rotation component based on the revolution driving force difference can be generated in the balls in the first or the second outermost ball row at earlier timing, and the rotation of the balls about their own axes in the first or the second outermost ball row can sequentially be transmitted to the balls of the ball rows toward the second or the first outermost ball row. Therefore, even if there is an odd number not less than three of the multiple ball rows, the balls of the adjacent ball rows can be brought into contact with each other and respectively rotated under the symmetrically inclined combined axes, and the balls in contact with each other can be moved (rotated) toward substantially the same side at the contact portion therebetween although not exactly in the same direction (reduction in frictional force).

(4) In the context of the configuration of (1), it may additionally be the case that

there are two of the multiple ball rows.

According to this configuration, since the balls in both ball rows revolve while being in contact with each other, rotation components are generated in opposite directions in the balls in both ball rows, so that even if the multiple ball rows are two rows, the balls of the adjacent ball rows can be brought into contact with each other and respectively rotated under the symmetrically inclined combined axes. Therefore, the balls in contact with each other can be moved (rotated) toward substantially the same side at the contact portion therebetween although not exactly in the same direction, and a reduction in frictional force can be achieved.

(5) In the context of the configuration of (1), it may additionally be the case that

raceway grooves for engagement with the multiple ball rows are respectively formed on at least one of an outer circumferential surface of the inner ring and an inner circumferential surface of the outer ring.

According to this configuration, even if no restricting parts are disposed on at least one of both outer side portions in the axial direction of the inner ring and both outer side portions in the axial direction of the outer ring, the multiple ball rows can appropriately be interposed between the inner ring and the outer ring such that movement in the axial direction to the outside of the inner ring and the outer ring is restricted.

(6) In the context of the configuration of (1), it may additionally be the case that

outer side portions in an axial direction of at least one of the inner ring and the outer ring are provided with restricting parts for restricting the multiple ball rows from moving in the axial direction to the outside of the inner ring and the outer ring on both sides in the axial direction of the inner ring and the outer ring.

According to this configuration, even if no raceway grooves for engagement with the multiple ball rows are respectively formed on at least one of the outer circumferential surface of the inner ring and the inner circumferential surface of the outer ring, the multiple ball rows can appropriately be interposed between the inner ring and the outer ring such that movement in the axial direction to the outside of the inner and outer rings is restricted.

(7) In the context of the configuration of (6), it may additionally be the case that

the restricting parts are disposed on at least one of both outer side portions in the axial direction of the inner ring and both outer side portions in the axial direction of the outer ring.

According to this configuration, even if no raceway grooves for engagement with the multiple ball rows are respectively formed on at least one of the outer circumferential surface of the inner ring and the inner circumferential surface of the outer ring, the multiple ball rows can appropriately be interposed between the inner ring and the outer ring according to a specific aspect such that movement in the axial direction to the outside of the inner and outer rings is restricted.

(8) In the context of the configuration of (7), it may additionally be the case that

there is an even number of the multiple ball rows.

According to this configuration, even if at least one of both outer side portions in the axial direction of the inner ring and both outer side portions in the axial direction of the outer ring are provided with the restricting parts for restricting the multiple ball rows from moving in the axial direction of the inner ring and the outer ring, and the multiple ball rows are integrally moved in the circumferential direction of the inner and outer rings while being restricted by the restricting parts, the movement direction based on the rotation of the balls about their own axes on both outer sides in the axial direction of the inner and outer rings faces the same side as the movement direction of the restricting parts relative to the multiple ball rows at contact portions with the restricting parts although not exactly in the same direction, so that the frictional force due to contact between the balls on both outer sides in the axial direction of the inner and outer rings and the restricting parts can be reduced as compared to when the movement direction based on the rotation of the balls about their own axes on both outer sides in the axial direction of the inner and outer rings is opposite to the movement direction of the restricting parts relative to the multiple ball rows at the contact portions with the restricting parts.

To achieve the second object, a configuration such as (9) may be employed in accordance with embodiments of the present invention.

(9) In a method of manufacturing a multirow ball bearing including multiple ball rows interposed between an inner ring and an outer ring, the outer ring being disposed on an outer circumferential side of the inner ring, such that the ball rows are adjacent to each other in an axial direction of the inner ring and the outer ring, the method includes

preparing as the outer ring a ring provided with multiple raceway grooves formed adjacently in the axial direction of the outer ring on an inner circumferential surface of the outer ring and a rod-shaped jig enabled to enter the inside of the outer ring;

first, inserting the jig from a first opening of the outer ring into the outer ring to form a guide path for the raceway groove closest to the first opening of the outer ring with an inserted tip end surface of the jig, and supplying the balls from a second opening of the outer ring into the outer ring to perform a ball loading operation of loading multiple balls into the raceway groove closest to the first opening of the outer ring;

subsequently, advancing the jig into the outer ring toward the second opening of the outer ring to sequentially form guide paths for the raceway grooves closer to the second opening of the outer ring than the raceway groove closest to the first opening of the outer ring, and performing the ball loading operation in each of the raceway grooves by using each of the guide paths each time the guide path is formed, so as to bring the balls in each of the raceway grooves into contact with balls adjacently arranged with gaps therebetween in a row direction in the raceway grooves adjacent to the raceway groove in a straddling manner between the adjacently arranged balls;

subsequently, after the ball loading operation for the raceway groove closest to the second opening of the outer ring is completed, bringing a first end surface to a first side in the axial direction of the inner ring into contact with the tip end surface of the jig; and

subsequently, moving the jig and the inner ring toward the first opening of the outer ring while maintaining a contacting relationship between the tip end surface of the jig and the first end surface of the inner ring so as to achieve a state in which an outer circumferential surface of the inner ring faces an inner circumferential surface of the outer ring.

According to this configuration, a type of the multirow ball bearing of (5) having the raceway grooves on the inner circumferential surface of the outer ring can specifically be manufactured.

### BENEFIT OF INVENTION

One or more of the embodiments described above may provide a multirow ball bearing capable of effectively dispersing a radial load while reducing frictional force when the inner ring and the outer ring rotate relative to each other. Embodiments of the present invention also make it possible to provide a multirow ball bearing manufacturing method for manufacturing such a multirow ball bearing.

### BRIEF DESCRIPTION OF DRAWINGS

Many aspects of the invention can be better understood with reference to the attached drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a longitudinal sectional view illustrating a multirow ball bearing according to a first embodiment.

FIG. 2 is a partially enlarged front view illustrating the multirow ball bearing according to the first embodiment.

FIG. 3 is an explanatory view for two-dimensionally explaining movement of balls (rolling elements) disposed on an inner ring (raceway surface) according to the first embodiment.

FIG. 4 is an explanatory view for two-dimensionally explaining components of rotation about z axes of balls on the inner ring.

FIG. 5 is an explanatory view for explaining coordinates of a right-hand system defined for explanation of a behavior of a ball on the inner ring (x axis: ball revolution direction; y axis: inner-ring axial direction; z axis: direction away from an inner-ring inner circumferential surface).

FIG. 6 is an explanatory view for explaining what combined axis is formed by a rotation component about the y axis and a rotation component about the z axis.

FIG. 7 is an explanatory view illustrating respective combined axes of balls in ball rows according to the first embodiment.

FIG. 8 is an explanatory view for explaining the frictional forces (dynamic frictional forces) that exist at contact portions between balls in each of a pair of mutually adjacent ball rows according to the first embodiment.

FIG. 9 is an explanatory view for explaining what happens to the frictional forces (dynamic frictional forces) at contact portions between balls in mutually adjacent ball rows when the balls of the ball rows rotate about the y axis.

FIG. 10 is an explanatory view for explaining a process of change of a combined axis SA to an optimum combined axis SA0.

FIG. 11 is an explanatory view for explaining dimensions, angles, and so forth of a specific structure according to the embodiment.

FIG. 12 is a partially enlarged explanatory view in which a portion of FIG. 11 is enlarged.

FIG. 13 is an explanatory view illustrating a manufacturing method according to the first embodiment.

FIG. 14 is a view for continuing the explanation from FIG. 13.

FIG. 15 is a view for continuing the explanation from FIG. 14.

FIG. 16 is a view for continuing the explanation from FIG. 15.

FIG. 17 is an explanatory view for two-dimensionally explaining a second embodiment (in a situation in which balls are arranged in three rows (an odd number of rows) on the inner ring (raceway surface)).

FIG. 18 is an explanatory view for two-dimensionally explaining a third embodiment (in a situation in which balls are arranged in two rows (an even number of rows) on the inner ring (raceway surface)).

FIG. 19 is a partial longitudinal sectional view illustrating a multirow ball bearing according to a fourth embodiment.

FIG. 20 is a partial longitudinal sectional view illustrating a multirow ball bearing according to a fifth embodiment.

FIG. 21 is an explanatory view for two-dimensionally explaining operation (motion of balls arranged on the inner ring (raceway surface)) of the fifth embodiment.

FIG. 22 is a diagram illustrating dimensions of a specific structure according to the embodiment.

FIG. 23 is a view for explaining basic dynamic load ratings of various bearings.

### DETAILED DESCRIPTION

Embodiments of the present invention will now be described with reference to the drawings.

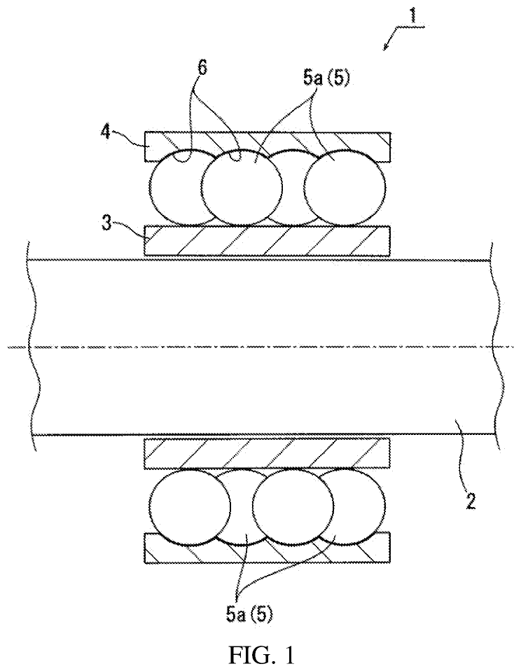

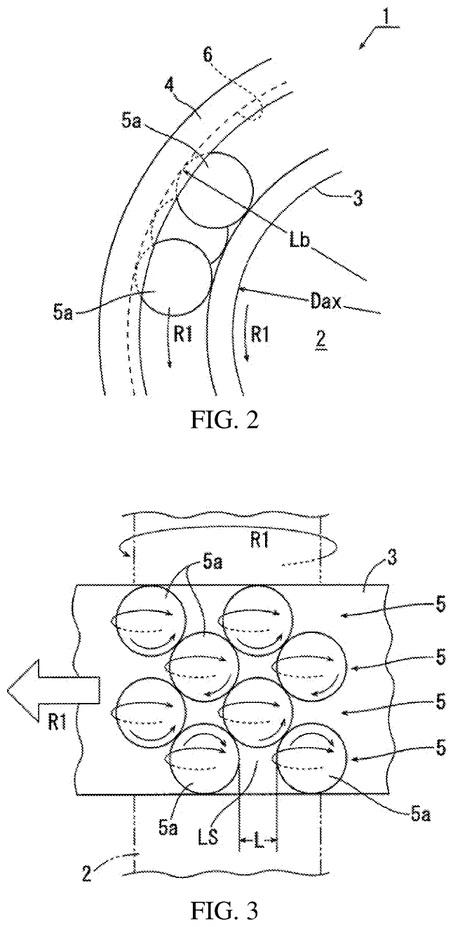

1. In FIGS. 1 and 2, reference numeral 1 denotes a multirow ball bearing serving as a bearing. This multirow ball bearing 1 includes an inner ring 3 for supporting a rotary shaft 2 serving as support shaft, an outer ring 4 disposed on the outer circumferential side of the inner ring 3, and multiple ball rows 5 interposed between the inner ring 3 and the outer ring 4.

(1) The inner ring 3 has an outer circumferential surface and an inner circumferential surface formed as smooth surfaces. The outer circumferential surface and the inner circumferential surface of the inner ring 3 preferably have constant width in the axial direction of the inner ring 3, the multiple ball rows 5 being arranged on the outer circumferential surface of the inner ring 3 which serves as raceway surface, while the rotation shaft 2 is appropriately supported by the inner circumferential surface of the inner ring 3 which is of adequate surface area for providing support with respect thereto.

(2) The outer ring 4 is disposed such that an inner circumferential surface thereof faces the outer circumferential surface of the inner ring 3. The inner circumferential surface of the outer ring 4 is provided with respective raceway grooves 6 for engagement with the multiple ball rows. The raceway grooves 6 are formed adjacently in a width direction of the outer ring 4 (axial direction; left-right direction in FIG. 1) over the entire inner circumferential surface of the outer ring 4, and in this embodiment, the outer ring 4 has four raceway grooves 6 formed in the width direction of the outer ring 4. The raceway grooves 6 each have an arcuate groove shape, and portions of balls 5a of the multiple ball rows 5 are inserted within (made to engage with) the raceway grooves 6 in a conforming state (rotatable state).

(3) As depicted in FIGS. 1 to 3, the multiple ball rows 5 are arranged between the inner ring 3 and the outer ring 4 so as to be adjacent to each other in the axial direction thereof. The ball rows 5 have portions on the outer ring 4 side partially entering the inside of the raceway grooves 6, and the balls 5a of the ball rows 5 are allowed to rotate (about their own axes), while being restricted from moving in the axial direction of the inner ring 3 and the outer ring 4, by the raceway grooves 6. In each of the ball rows 5, the balls 5a of the ball row 5 are arranged with prescribed gaps L therebetween in a row direction of the ball row 5, and the ball rows 5 adjacent to the ball row 5 are arranged in staggered fashion so as to be shifted relative thereto in the row direction of the ball row 5. The respective balls 5a of a ball row 5 face spaces LS formed by the gaps L in the ball rows 5 adjacent to that ball row 5, each of the respective balls 5a being brought into contact with two of the balls 5a that define one of the gaps L.

(4) In the multirow ball bearing 1 as described above, while the rotation shaft 2 is integrated with the inner circumferential surface of the inner ring 3, the outer circumferential surface of the outer ring 4 is attached to an attachment member (not depicted), and when the inner ring 3 is rotated, as depicted in FIG. 3, the balls 5a between the inner ring 3 and the outer ring 4 integrally revolve relative to the inner ring 3 in the same direction as a rotation direction R1 of the inner ring 3 (rotation direction of the rotation shaft 2) and each basically rotates about its own axis in a direction opposite to the rotation direction R1 of the inner ring 3 (described in detail later). Therefore, the inner ring 3 and the outer ring 4 rotate relative to each other, and the multirow ball bearing 1 fulfills the function of a bearing.

2. In the multirow ball bearing 1 as described above, although the balls 5a rotate in contact with the surrounding balls 5a, a reduction in frictional force is achieved. This will specifically be described.

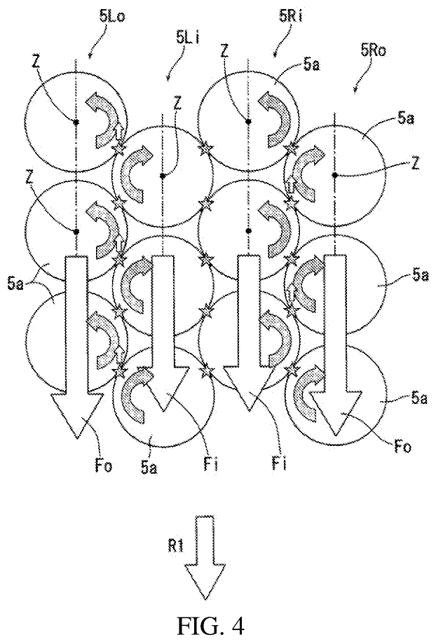

(1) FIG. 4 illustrates how the balls 5a of the ball rows 5 specifically operate in the state of FIG. 3. In this case, the four ball rows 5 (an even number of rows) are sequentially arranged in the width direction (left-right direction in FIG. 4) on the outer circumferential surface of the inner ring 3 (not depicted in FIG. 4), and in each of the ball rows 5, the balls 5a are arranged with prescribed gaps L therebetween in the row direction, each of the respective balls 5a of any given ball row 5 being brought into contact with two of the balls 5a that define one of the prescribed gaps L in the ball row(s) 5 adjacent to that ball row 5.

(2) In such a structure, when the inner ring 3 and the outer ring 4 rotate relative to each other, the four ball rows 5 integrally revolve in the rotation direction of the inner ring 3, and the balls 5a of the ball rows 5 each basically rotates about its own axis in a direction opposite to the revolution direction R1 as described above (see FIG. 3).

In this case, as compared to a revolution driving force (driving force for revolution) Fo of the left and right outermost ball rows 5 located on both outer sides in the width direction of the inner ring 3 (hereinafter, the left outermost ball row and the right outermost ball row in FIG. 4 will be referred to as left outer ball row 5Lo and right outer ball row 5Ro, respectively), a revolution driving force Fi becomes relatively small in the ball rows 5 disposed inside the two ball rows 5Lo, 5Ro (hereinafter, the ball row adjacent to the left outer ball row 5Lo and the ball row adjacent to the right outer ball row 5Ro will referred to as left inner ball row 5Li and right inner ball row 5Ri, respectively). This is because the outer ball rows 5Lo, 5Ro are each brought into contact with the inner ball row 5Li (or 5Ri) only on the inside (i.e., on only one side) in the width direction, while the inner ball rows 5Li, 5Ri are brought into contact with the other ball rows 5 on both sides in the width direction (the left-right direction in FIG. 4) so that a movement resistance (brake torque) for each of the inner ball rows 5Li, 5Ri is doubled as compared to the movement resistance for each of the outer ball rows 5Lo, 5Ro. Moreover, it is thought that this is also related to a displacement in the revolution direction due to elastic deformation between the balls 5a.

(3) A relative difference between the revolution driving force Fi of the inner ball rows 5Li, 5Ri and the revolution driving force Fo of the outer ball rows 5Lo, 5Ro affects the rotation of each of the balls 5a of the ball rows 5 about its own axis.

When the relative rotation between the inner ring 3 and the outer ring 4 causes the revolution driving force Fi of the inner ball rows 5Li, 5Ri to be less than the revolution driving force Fo of the outer ball rows 5Lo, 5Ro as described above, the balls 5a (lower portions in FIG. 4) of the outer ball rows 5Lo, 5Ro applies a pressing force to the balls 5a (upper portions in FIG. 4) of the inner ball rows 5Li, 5Ri in the revolution direction R1 at contact portions (stars in FIG. 4) between the balls 5a of the outer ball rows 5Lo, 5Ro and the balls 5a of the inner ball rows 5Li, 5Ri, so that a reaction force acts as the reaction on the balls 5a of the outer ball rows 5Lo, 5Ro in the direction opposite to the revolution direction R1 (see outlined arrows in FIG. 4). This reaction force has a point of action (contact portion) of the reaction force offset relative to a polar axis (z axis described later) of each of the balls 5a in the outer ball rows 5Lo, 5Ro and therefore generates a rotation component about the polar axis for each of the balls 5a in the outer ball rows 5Lo, 5Ro. In this case, at the contact points of the balls 5a of the inner ball row 5Li (5Ri) with the balls 5a of the outer ball row 5Lo (5Ro), the input to the contact points on the front side in the revolution direction R1 (lower contact points of the balls 5a in the outer ball row 5Lo (5Ro) in FIG. 4) becomes larger than the input to the contact points on the rear side in the revolution direction R1 (upper contact points of the balls 5a in the outer ball row 5Lo (5Ro) in FIG. 4) based on the relative difference between the revolution driving force Fi of the inner ball rows 5Li, 5Ri and the revolution driving force Fo of the outer ball rows 5Lo, 5Ro. Therefore, under the condition that the balls 5a of the ball rows 5 are rotatably sandwiched between the inner ring 3 and the outer ring 4, the rotation component based on the relative difference between the revolution driving force Fo of the outer ball row 5Lo (5Ro) and the revolution driving force Fi of the inner ball row 5Li (5Ri) is added to a basic rotation component based on the relative rotation between the inner ring 3 and the outer ring 4, so that the rotation of each of the balls 5a in the outer ball rows 5Lo, 5Ro about its own axis is a combined rotation thereof.

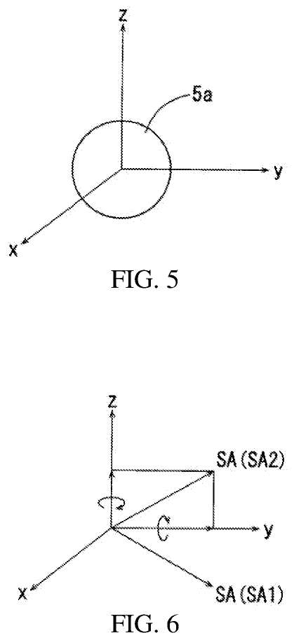

(4) The rotation of each of the balls 5a of the outer ball rows 5Lo, 5Ro about its own axis will more specifically be described with coordinates of a right-hand system established by using the center of each of the balls 5a of the ball rows 5 on the inner circumferential surface of the inner ring 3 as the origin, the x axis, y axis, and z axis being respectively defined as a transfer direction of the ball 5a (the revolution direction R1), the axial direction of the inner ring 3, and an upper direction (direction away from the inner circumferential surface of the inner ring 3), as depicted in FIG. 5.

Under this coordinate system, regarding the rotation of the balls 5a of the outer ball rows 5Lo, 5Ro about their own axes, the basic component based on the relative rotation between the inner ring 3 and the outer ring 4 is a rotation component about the y axis, and the component based on the relative difference between the revolution driving force Fo of the outer ball row 5Lo (5Ro) and the revolution driving force Fi of the inner ball row 5Li (5Ri) (the component based on the reaction force) is a component about the z axis (denoted by symbol z) as depicted in FIG. 4. In this case, the rotation components of all the balls 5a about the z axis in the outer ball rows 5Lo, 5Ro are in the same direction in the same rows, while the direction of the rotation components of the balls 5a about the z axis in the left outer ball row 5Lo is opposite to the direction of the rotation components of the balls 5a about the z axis in the right outer ball row 5Ro (see arrows in the counterclockwise direction for the balls 5a of the left outer ball row 5Lo and arrows in the clockwise direction for the balls 5a of the right outer ball row 5Ro in FIG. 4).

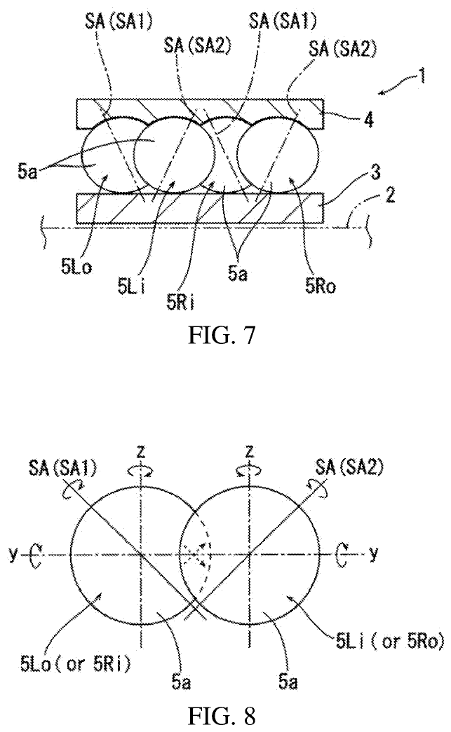

As a result, the rotation of the balls 5a in the outer ball rows 5Lo, 5Ro about their own axes is rotation about a combined axis SA of the y axis and the z axis and, as depicted in FIG. 6, the combined axis SA is inclined on a y-z plane in the coordinate system at an angle corresponding to a ratio of the number of rotations about the y axis and the number of rotations about the z axis. In this case, the combined axes SA1 and SA2 are depicted in FIG. 6 as combined axes SA arranged symmetrically about the y axis (denoted by symbol y) in the y-z plane, this being meant to indicate the combined axes that exist when rotation occurs in either rotational direction about the z axis when rotation occurs in one rotational direction about the y axis. Therefore, as depicted in FIG. 7, the balls 5a of the left and right outer ball rows 5Lo, 5Ro rotate (about their own axes) in opposite directions about the symmetrically inclined combined axes SA (SA1, SA2).

(5) When the rotation component is generated about the z axis in each of the balls 5a of the outer ball row 5Lo (5Ro) as described above, the rotation component of each of the balls 5a of the outer ball row 5Lo (5Ro) is accordingly transmitted to each of the balls 5a of the inner ball row 5Li (5Ri) adjacent thereto on the inner side of the outer ball row 5Lo (5Ro) as a rotation component in the opposite direction about the z axis (reaction) and, as in the case of the balls 5a of the outer ball row 5Lo (5Ro), the rotation component (rotation component about the z axis) of each of the balls 5a in the inner ball row 5Li (5Ri) is combined with the rotation component (basic rotation component) about the y axis, so that, as depicted in FIG. 7, the combined axis SA of each of the balls 5a of the inner ball row 5Li (5Ri) is in a symmetrical inclined state with respect to the combined axis SA of each of the balls 5a in the outer ball row 5Lo (5Ro) adjacent to the inner ball row 5Li (5Ri). Therefore, all the balls 5a of the inner ball rows 5Li (5Ri) rotate (about their own axes) about the inclined combined axes SA (SA1 or SA2) in the direction opposite to the rotation direction of the balls 5a of the outer ball row 5Lo (5Ro) adjacent to the inner ball row 5Li (5Ri). As depicted in FIG. 8, the balls 5a of both of the rows 5Lo, 5Li (5Ro, 5Ri) move (rotate) at the contact portion (see a central portion in FIG. 8) in directions toward the same side (the right side in FIG. 8) (see crossing dashed arrows in the central portion in FIG. 8) although the directions of the movement (rotation) are not exactly the same.

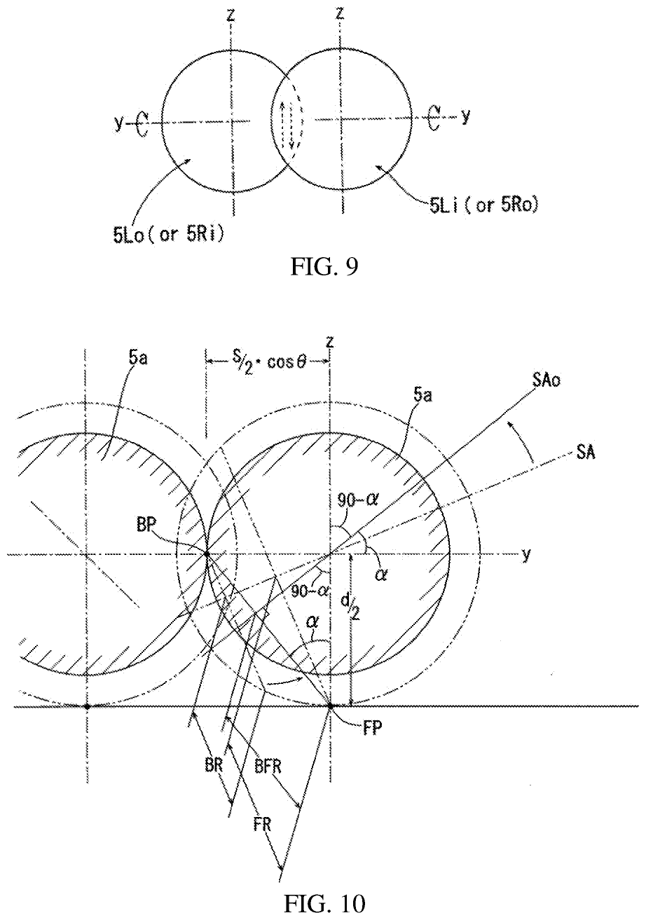

In contrast, assuming that each of the balls 5a of the outer ball row 5Lo (5Ro) only rotates about the y axis without rotating about the z axis, the inclined combined axis SA is not formed in each of the balls 5a of the outer ball row 5Lo (5Ro) so that the balls 5a of the outer ball row 5Lo (5Ro) and the balls 5a of the inner ball row 5Li (5Ri) rotate about the y axis. Therefore, as depicted in FIG. 9, the balls 5a of the outer ball row 5Lo (5Ro) and the balls 5a of the inner ball row 5Li (5Ri) move (rotate) at the contact portion (see a central portion in FIG. 9) in opposite directions (see parallel dashed arrows in the central portion in FIG. 9).

The same phenomenon as this phenomenon also occurs in the case that balls of ball rows in the multirow ball bearing are arranged continuously in contact with each other.

As a result, when the balls 5a of the outer ball row 5Lo (5Ro) rotate about the z axis, the frictional force is reduced as compared to the situation that exists when the balls 5a of the outer ball row 5Lo (5Ro) rotate about the y axis without rotating about the z axis.

(6) As in the case of the outer ball row 5Lo (5Ro) and the inner ball row 5Li (5Ri), as depicted in FIG. 4, the balls 5a of the left inner ball row 5Li and the balls 5a of the right inner ball row 5Ri are in contact with each other so that the balls 5a transmit the rotation components in the opposite directions about the z axis to each other. The balls 5a of the left inner ball row 5Li and the balls 5a of the right inner ball row 5Ri each have the combined axis SA formed by the rotation component about the z axis and the rotation component about the y axis, so that the balls 5a of the left inner ball row 5Li and the balls 5a of the right inner ball row 5Ri each rotate about the combined axis SA.

In this case, the combined axes SA of the balls 5a of the left inner ball row 5Li and the balls 5a of the right inner ball row 5Ri are in a symmetrically inclined state (see FIG. 7). The balls 5a in both of the ball rows 5Li, 5Ri move (rotate) at the contact portion in directions toward the same side although the directions of the movement (rotation) are not exactly the same, which is equivalent to the case depicted in FIG. 8. Therefore, the balls 5a of the left inner ball row 5Li and the balls 5a of the right inner ball row 5Ri are in contact with each other while maintaining a state in which rotation thereof about their own axes is not mutually prevented as much as possible, so that a transmission path promoting smooth rotation of the balls 5a in the ball rows 5 about their own axes is formed between the left outer ball row 5Lo and the right outer ball row 5Ro.

(7) As depicted in FIG. 10, the combined axis SA of each of the balls 5a in the ball rows 5 ultimately attains an optimum combined axis SA0 (a combined axis forming a rotation locus passing through both of the contact point between the ball 5a and the ball 5a of the ball row 5 adjacent to the ball 5a, and the contact point between the ball 5a and the inner circumferential surface of the inner ring 3).

As described above, when the rotation component about the z axis acts on each of the balls 5a, the combined axis SA is formed in cooperation with the rotation component about the y axis, and the ball 5a rotates about the combined axis SA (see FIG. 7). As depicted in FIG. 10, this combined axis SA initially has a smaller inclination angle relative to the y axis than an inclination angle α of the optimum combined axis SA0 relative to the y axis. When the ball 5a rotates about the combined axis SA, a rotation radius BR passing through a contact point BP of the ball 5a with the ball 5a of the adjacent ball row 5 is smaller than a rotation radius FR passing through a contact point FP of the ball 5a with the inner circumferential surface of the inner ring 3. This causes a slip, and the frictional resistance at the contact point BP between the balls 5a limits the rotation component about the y axis, so that the rotation component about the z axis becomes relatively larger. As a result, the inclination angle of the combined axis SA relative to the y axis gradually increases (the combined axis SA comes closer to the optimum combined axis SA0), and the combined axis SA attains the optimum combined axis SA0 forming a rotation locus (rotation radius BFR) passing through both of the contact point BP between the ball 5a and the ball 5a of the ball row 5 adjacent to the ball 5a and the contact point FP between the ball 5a and the inner circumferential surface of the inner ring 3. The rotation of the ball 5a based on the optimum combined axis SA0 causes the least slip (the least frictional resistance) at the contact point BP with the ball 5a of the adjacent ball row 5, and the ball 5a rotates most efficiently and stably.

(8) The optimum combined axis SA0 will more specifically be described.

As is apparent from FIG. 10, an angle α made by the optimum combined axis SA0 relative to the y axis is equal to an angle formed by a line (line projected onto y-z plane) passing through both the contact point BP between the ball 5a and the ball 5a of the ball row 5 adjacent to the ball 5a and the contact point FP between the ball 5a and the inner circumferential surface of the inner ring 3 relative to the z axis.

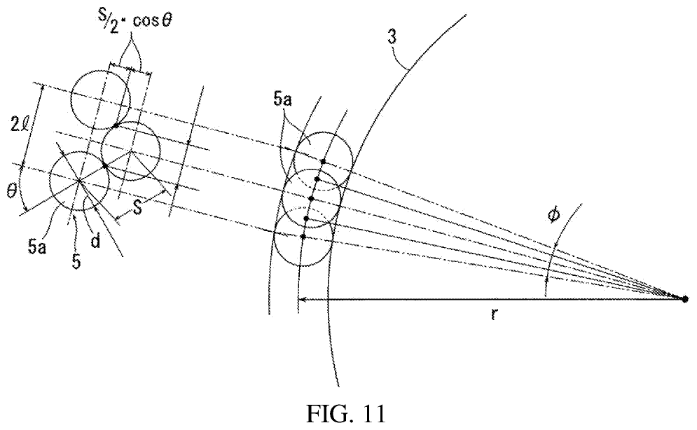

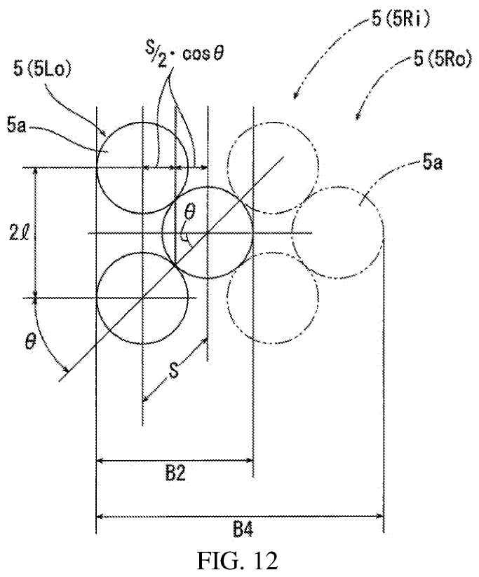

Therefore, as depicted in FIGS. 11 and 12, assuming that the balls 5a in contact with each other in the adjacent ball rows 5 have a center-to-center distance of s and a contact angle of θ, the projection radius on the y-z plane of the contact point BP in each of the balls 5a can be expressed by using the distance s and the contact angle θ as s/2·cos θ and, in this case, the distance s is equal to the diameter d of the ball 5a, and therefore, the angle α formed by the projected line (see FIG. 10) simultaneously passing through the contact point BP and the contact point FP relative to the z axis can be expressed from the relationship depicted in FIG. 10 as follows:

tan α=tan [(s/2·cos θ)/(d/2)]=tan(cos θ).

Therefore, the angle α formed by the optimum combining axis SA0 relative to the y axis is a (rad)=cos θ.

Note that θ is preferably set so as to satisfy 30°<θ<90°. This is in order that the balls (rolling elements) 5a of the same ball row 5 are not brought into contact with each other when the multiple ball rows 5 are formed.

Therefore, more specifically, 30°<0 leads to

α=cos θ<(3^{1/2}/2)×(180/π)=49.6°,

based on which it is found in a preferred embodiment that the angle α formed by the optimum combined axis SA0 relative to the y axis does not exceed 49.6°.

Therefore, in the case of this embodiment, as compared to a frictional resistance F in the case that the balls 5a are continuously brought into contact with each other in the row direction in the same ball row 5, the frictional force is reduced to F cos (α)=F cos 49.6°>0.648×F, since a crossing angle is formed by movement directions at the contact point between the balls 5a in the adjacent ball rows 5.

In FIGS. 11 and 12, r denotes a distance between the center of the ball (rolling element) 5a on the inner ring 3 and the axis of the inner ring 3 (the axis of the multirow ball bearing 1), and y denotes a central angle between center points of the adjacent balls 5a in the same ball row 5 when r is used as the radius.

(9) As described above, in the first embodiment, each of the balls 5a of each of the ball rows 5 is brought into contact with two of the balls 5a arranged adjacently in the row direction in the ball row 5 adjacent to the ball row 5 while rotating about its own axis. However, the contacting balls 5a move (rotate) toward substantially the same side at both contact portions, so that the frictional force can significantly be reduced as compared to when the movement directions of the contact portions of the contacting balls 5a are opposite to each other (see FIGS. 8 and 9).

In the case of this embodiment (four ball row arrangement), basically, the revolution driving force Fo of the outer ball row 5Lo (5Ro) is made larger than the revolution driving force Fi of the inner ball row 5Li (5Ri) so that the rotation component about the z axis can be obtained in the balls 5a of the ball rows 5. A revolution driving force difference (Fo-Fi) is preferably made larger at the start of rotation between the outer ball row 5Lo (5Ro) and the inner ball row 5Li (5Ri). This is so as to not only make it possible for the balls 5a of the ball rows 5 to stably obtain the rotation component about the z axis, but so as to also make it possible for the combined axis SA to rapidly attain the state of the optimum combined axis SA0 and thus make the multirow ball bearing preferable in terms of reduction in initial rotation resistance. Therefore, specifically, it is preferable, for example, to make the elastic modulus of each of the balls 5a of the outer ball row 5Lo (5Ro) greater than the elastic modulus of each of the balls 5a of the inner ball row 5Li (5Ri) (e.g., steel having an elastic modulus of on the order of 200 GPa might be employed for the balls of the inner ball row, and ceramic or the like having an elastic modulus of on the order of 300 GPa might be employed for the balls of the outer ball row, so as to cause the elastic modulus of the balls of the outer ball row to be on the order of 1.5 times greater than the elastic modulus of the balls of the inner ball row), to make the diameter of each of the balls 5a of the inner ball row 5Li (5Ri) smaller by on the order of several μm than the diameter of each of the balls 5a of the outer ball row 5Lo (5Ro) (so as to cause there to be a difference in diameter therebetween), and/or the like.

Note that where a difference in elastic modulus produces a difference in diameter such as when a load acting on a multirow ball bearing in accordance with an embodiment of the present invention causes some ball(s) thereamong to be compressed more by that load than other ball(s) thereamong, as a result of which radial distance(s) from the multirow ball bearing axis to the center(s) of such lower-modulus (more-compressed) ball(s) is made less than radial distance(s) from the multirow ball bearing axis to the center(s) of such higher-modulus (less-compressed) ball(s), difference(s) in ball diameter(s) arising as a result of such difference(s) in elastic modulus should be understood to be an example of what is meant herein by a difference in diameter between the balls of the respective rows. For example, where balls of nominally identical diameter under no load are employed at the respective rows in a multirow ball bearing in accordance with an embodiment of the present invention but a difference in elastic modulus between subsets of those balls causes some to be compressed more under load than others, in the context of a preferred embodiment for achieving reduction in initial rotation resistance as described above the ball diameter referred to herein should be understood to be not the nominal diameter under no load but the compressed diameter under load; but note that in other contexts the ball diameter referred to herein may reasonably be understood to be the nominal diameter under no load.

3. Even if a radial load (radial inward load) acts on the outer ring 4, the multirow ball bearing 1 can bear the radial load acting on the outer ring 4 in approximately uniform fashion and can effectively disperse the radial load acting on the outer ring 4. This is because each of the balls 5a of each of the ball rows 5 is brought into contact with the balls 5a arranged adjacently in the row direction in the ball rows 5 adjacent to the ball row 5 so that the balls 5a do not individually freely roll and move (the balls integrally revolve while rotating about their own axes when the inner and outer rings 3, 4 relatively rotate). Therefore, it is possible for the merits of the multirow arrangement to be sufficiently reflected in terms of increase in basic dynamic load rating and longer operating life.

Moreover, to the extent that collisions between the balls 5a due to the rolling movement of the balls 5a can be eliminated, it will be possible in such case to prevent the balls 5a from being damaged and from generating noise due to the collisions that would otherwise occur.

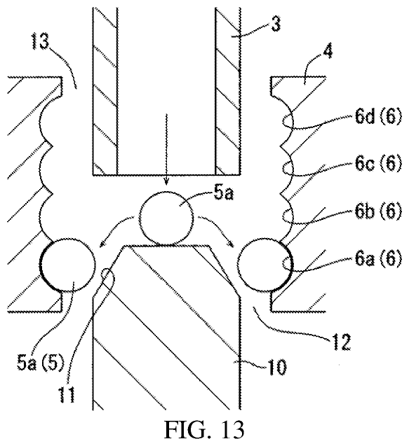

4. A method of manufacturing the multirow ball bearing 1 will be described with reference to FIGS. 13 to 16.

(1) First, outer ring 4 and rod-shaped jig 10 are prepared so that they are available as members for use in this manufacturing method.

The member used as the outer ring 4 has an inner circumferential surface provided with multiple raceway grooves 6 adjacent to each other in the axial direction as described above (see FIG. 13), and the member used as the rod-shaped jig 10 can be inserted into the outer ring 4 and has a tip end portion provided with a guide surface 11 having a diameter reduced from the inner side in the axial direction toward a tip end surface of the jig 10 (see FIG. 13).

(2) Subsequently, as depicted in FIG. 13, the jig 10 is inserted into the outer ring 4 from a first opening 12 thereof to form a guide path for a raceway groove 6a closest to the opening 12 with the guide surface 11 (inserted tip end surface) of the jig 10, and the balls 5a are then supplied from a second opening 13 of the outer ring 4 into the outer ring 4 to perform a ball loading operation of loading the multiple balls 5a into the raceway groove 6a. This is because the balls 5a are guided to the raceway groove 6 without dropping the balls 5a from between the jig 10 and the inner circumferential surface of the outer ring 4 even when the ball loading operation is performed. In this operation, the balls 5a are loaded in the raceway groove 6a such that prescribed gaps S are formed between the adjacent balls 5a in the raceway groove 6a.

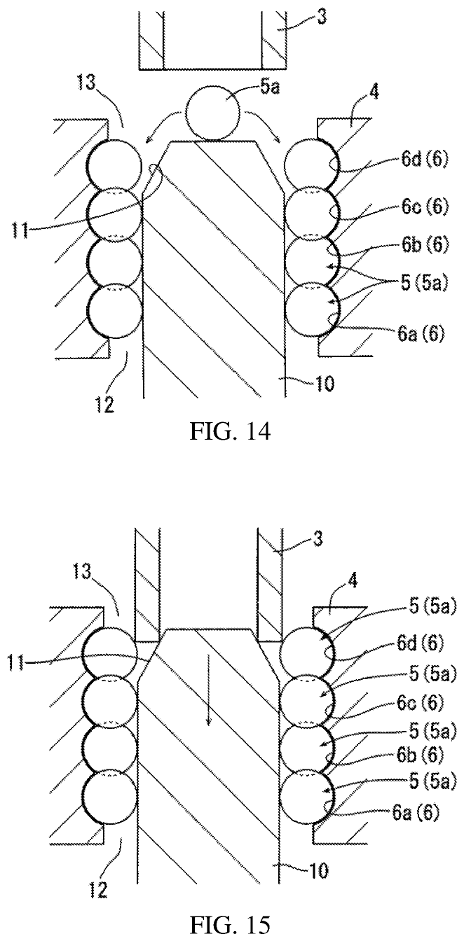

(3) After the loading operation of the balls 5a into the raceway groove 6a is completed, the jig 10 is advanced into the outer ring 4 toward the second opening 13 to sequentially form guide paths for raceway grooves 6b, 6c, 6d closer to the second opening 13 than the raceway groove 6a, and the ball loading operation is performed in each of the raceway grooves 6 by using each of the guide paths each time the guide path is formed (see FIGS. 13 and 14). Additionally, in this operation, the balls 5a in the raceway grooves 6b, 6c, 6d are brought into contact with the adjacent balls 5a in straddling fashion such that there are gaps therebetween in the row direction in the raceway grooves 6 adjacent to the raceway grooves 6b, 6c, 6d.

(4) After the ball loading operation for the raceway groove 6d closest to the second opening 13 of the outer ring 4 is completed, a first end surface to a first side in the axial direction of the inner ring 3 brought into contact with the tip end surface of the jig 10 as depicted in FIG. 15. This is because the guide surface 11 of the jig 10 is used for restricting the displacement movement of the inner ring 3 in the radial direction when a placement operation is performed for positioning the inner ring 3 at a desired position relative to the outer ring 4.

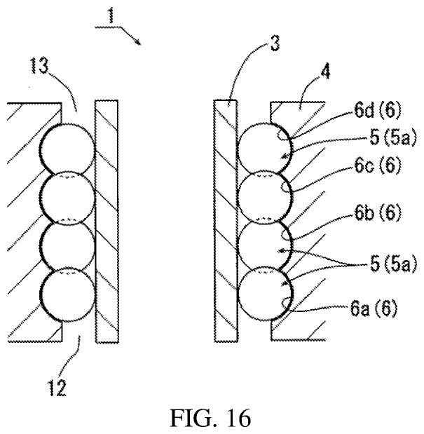

(5) After the first end surface of the inner ring 3 is brought into contact with the tip end surface of the jig 10, as depicted in FIGS. 15 and 16, the jig 10 and the inner ring 3 are moved toward the first opening 12 of the outer ring 4 while maintaining the contacting relationship between the guide surface 11 of the jig 10 and the first end surface of the inner ring 3 so as to achieve a state in which the outer circumferential surface of the inner ring 3 faces the inner circumferential surface of the outer ring 4. This is because the inner ring 3 is guided to the position at which the outer circumferential surface thereof faces the inner circumferential surface of the outer ring 4 while the outer circumferential surface of the jig 10 and the outer circumferential surface of the inner ring 3 restricts the balls 5a loaded in the raceway grooves 6 from falling off.

(6) This leads to a configuration in which the multiple ball rows 5 are interposed between the inner ring 3 and the outer ring 4, and the multirow ball bearing 1 is manufactured. In this case, a fastener is attached for restricting a relative movement of the inner ring 3 and the outer ring 4 in the axial direction.

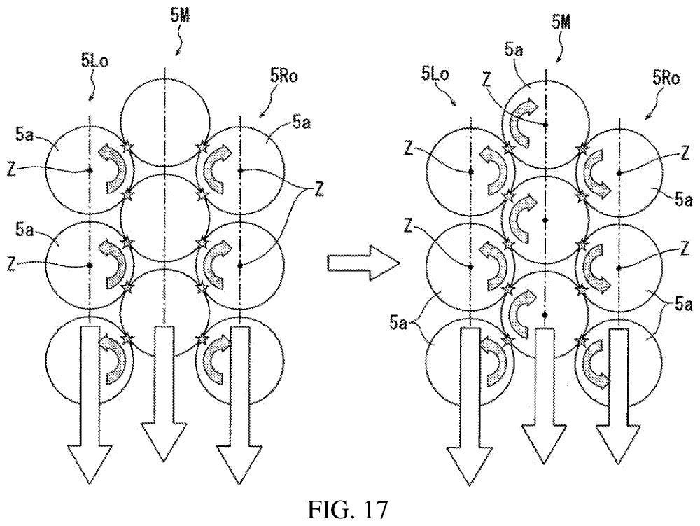

5. FIG. 17 illustrates a second embodiment. The second embodiment is a modification of the first embodiment (the multirow ball bearing 1) and is illustrated as the ball rows 5 arranged in three rows (an odd number of rows) in the width direction (left-right direction in FIG. 17) on the outer circumferential surface of the inner ring 3 (not depicted in FIG. 17). In the second embodiment, the same constituent elements as those of the first embodiment are denoted by the same reference numerals and will not be described.

(1) In the structure (the ball rows 5 arranged in three rows), regarding the balls 5a of the left and right outer ball rows 5Lo, 5Ro, as in the case of the ball rows 5 arranged in four rows (an even number of rows), the directions of the rotation components about the z axis of all the balls 5a in the outer ball rows 5Lo, 5Ro become the same directions in the same rows due to the relative rotation between the inner ring 3 and the outer ring 4, while the direction of the rotation components about the z axis of the balls 5a of the left outer ball row 5Lo is made different from the direction of the rotation component about the z axis of the balls 5a in the right outer ball row 5Ro (see, specifically, arrows in the counterclockwise direction for the rotation components of the balls 5a in the left outer ball row 5Lo and arrows in the clockwise direction for the rotation components of the balls 5a in the right outer ball row 5Ro in a left portion in FIG. 4). On the other hand, equal rotation forces in opposite directions are transmitted to the balls 5a of a central row (inner ball row) 5M from the balls 5a of the left and right outer ball rows 5Lo, 5Ro in terms of the rotation component about the z axis, which attempts to make the balls 5a of the inner ball row that is the central row non-rotatable about the z axis (see the left portion in FIG. 17).

However, the inventor of the present invention thinks that if various variations exist at a normal level, balance is slightly disrupted between the contact resistance of the balls 5a of the central row 5M with respect to the balls 5a of the outer row 5Lo and the contact resistance of the balls 5a of the central row 5M with respect to the balls 5a of the outer row 5Ro and a larger driving force (reaction force) can be generated in the outer ball row 5Lo (or 5Ro) on a first side as compared to a second side although instability exists. Therefore, if a larger driving force (reaction force) is generated in the outer ball row 5Lo (or 5Ro) on one side as compared to the other side, the rotation component about the z axis is generated at earlier timing in the balls 5a in the outer ball row 5Lo (or 5Ro) on the one side (see counterclockwise rotation arrows in a right portion in FIG. 17), and this rotation component and the rotation component about the y axis form the combined axis SA in the balls 5a of the outer ball row 5Lo (or 5Ro) on the one side, and the balls 5a rotate about the combined axis SA.

Since the rotation component about the z axis is generated in the balls 5a in the outer ball row 5Lo (or 5Ro) on the one side, the rotation component is sequentially transmitted to the balls 5a in the central row 5M and the balls 5a in the outer ball row 5Ro (or 5Lo) on the other side (see clockwise and counterclockwise rotation arrows in the right portion in FIG. 17). And, the rotation components about the z axis and the rotation component about the y axis form the alternately (symmetrically) inclined combined axes SA in the balls 5a of the central row 5M and the balls 5a of the outer ball row 5Ro (or 5Lo) on the other side, so that the balls 5a in the central row 5M and the balls 5a of the outer ball row 5Ro (or 5Lo) on the other side rotate about the combined axes SA.

(2) However, if the operation of the balls 5a of the ball rows 5 is left to various variations of a normal level as described above, the operation lacks stability and reliability.

Therefore, in this embodiment, the balance is appropriately disrupted between the contact resistance of the balls 5a in the central row 5M with respect to the balls 5a in the outer row 5Lo and the contact resistance of the balls 5a of the central row 5M with respect to the balls 5a in the outer row 5Ro, so that the rotation component about the z axis is inevitably generated at earlier timing in the balls 5a in the outer ball row 5Lo (or 5Ro) on one side. Specifically, the balance between the contact resistance of the balls 5a in the central row 5M with respect to the balls 5a in the outer row 5Lo and the contact resistance of the balls 5a of the central row 5M with respect to the balls 5a in the outer row 5Ro may reliably be slightly disrupted by causing the balls 5a of the outer ball rows 5Lo, 5Ro to be made of different materials, making the diameters of the balls 5a of the outer ball rows 5Lo, 5Ro different by about several μm to change the resistance, disposing a slight step on the inner circumference surface of the inner ring 3 to change the resistance, and/or the like.

In this case as well, the combined axis SA of each of the balls 5a in the ball rows 5Lo, 5M, 5Ro transitions to the optimum combined axis SA0 over time.

(3) Therefore, regarding a frictional force reduction, as in the multirow ball bearing 1 having the ball rows 5 arranged in four rows (an even number of rows), the multirow ball bearing 1 having the ball rows 5 arranged in three rows (an odd number of rows) can reduce the frictional force as compared to when the movement directions of the contact portions between the balls 5a are opposite to each other (see FIG. 9).

In FIG. 17, only the rotation component about the z axis is depicted, and the rotation component about the y axis is not depicted.

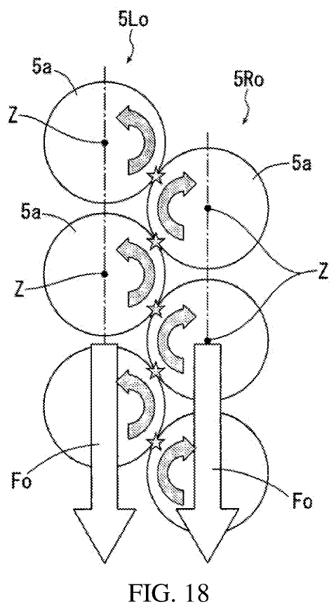

6. FIG. 18 illustrates a third embodiment. The third embodiment is a modification of the first and second embodiments (the multirow ball bearing 1) and is illustrated as the ball rows 5 arranged in two rows (an even number of rows) in the width direction (left-right direction in FIG. 18) on the outer circumferential surface of the inner ring 3 (not depicted in FIG. 18). In the third embodiment, the same constituent elements as those of the first and second embodiments are denoted by the same reference numerals and will not be described.

(1) When the ball rows 5 are arranged in two rows, the balls 5a in the left and right outer ball rows 5Lo, 5Ro are brought into contact with each other without an inner ball therebetween, and the same revolution driving force Fo acts on the two outer ball rows 5Lo, 5Ro due to the relative rotation of the inner and outer rings 3, 4. In this case, each of the balls 5a in the outer ball rows 5Lo, 5Ro inputs to the ball 5a in contact with the ball 5a a pressing force based on the revolution driving force Fo from a contact point on the front side in the revolution direction R1 (a lower contact point of each of the balls 5a in the outer ball row 5Lo (5Ro) in FIG. 18), and so that a reaction force acts as the reaction on the balls 5a applying the pressing force. This reaction force has a point of action (contact portion) of the reaction force offset relative to the z axis of each of the balls 5a and therefore generates a rotation component about the z axis (moment about the z axis) for each of the balls 5a in the outer ball rows 5Lo, 5Ro. Therefore, the symmetrically inclined combined axes SA are respectively formed in the balls 5a in the outer ball rows 5Lo, 5Ro by the rotation component about the z axis and the rotation component about the y axis, and the balls 5a in the outer ball rows 5Lo, 5Ro are respectively rotated about the combined axes SA.

In this case as well, the combined axis SA of each of the balls 5a in the ball rows 5Lo, 5Ro transitions to the optimum combined axis SA0 over time.

(2) Therefore, regarding a frictional force reduction, as in the multirow ball bearing 1 having the ball rows 5 arranged in four rows (an even number of rows), the multirow ball bearing 1 having the ball rows 5 arranged in two rows (an even number of rows) can reduce the frictional force as compared to when the movement directions of the contact portions between the balls 5a are opposite to each other (see FIG. 9).

In FIG. 18, only the rotation component about the z axis is depicted, and the rotation component about the y axis is not depicted.

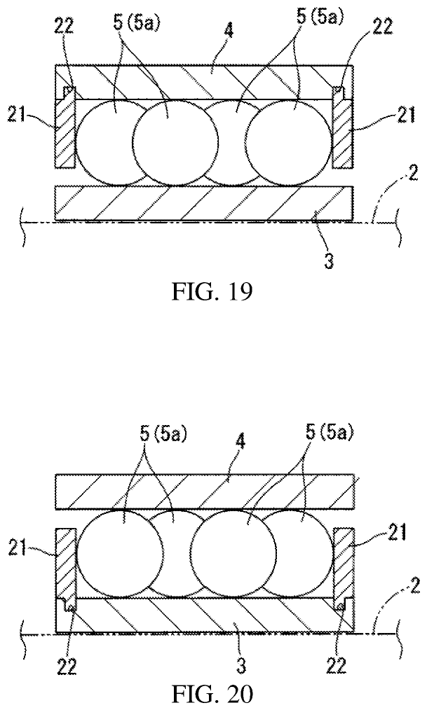

7. FIG. 19 illustrates a fourth embodiment. The fourth embodiment illustrates a modification of the first embodiment. In the fourth embodiment, the same constituent elements as those of the first embodiment are denoted by the same reference numerals and will not be described.

In the fourth embodiment, guide parts (restricting parts) 21 are disposed on both outer side portions in the axial direction of the outer ring 4 over the entire circumferences thereof, and the multiple ball rows 5 are restricted by the guide parts 21 from moving in the axial direction to the outside of the inner ring 3 and the outer ring 4.

Specifically, the inner circumferential surface of the outer ring 4 is provided with attachment grooves 22 formed over the entire circumferences on both sides in the width direction (both sides in the axial direction), and expandable/contactable rings such as so-called C rings are used as the guide parts 21, so that the guide parts 21 are made to engage with the attachment grooves 22 by using the expandable/contactable properties thereof. Accordingly, the outer circumferential surface of the inner ring 3 and the inner circumferential surface of the outer ring 4 are formed as smooth raceway surfaces, and the raceway grooves 6 for engagement with the multiple ball rows 5 are formed on neither the inner ring 3 nor the outer ring 4.

When this multirow ball bearing 1 is manufactured, the guide part 21 is attached in advance to a side portion on a first side in the axial direction of the outer ring 4, the balls 5a are loaded from a second side opposite the first side in the axial direction of the outer ring 4 between the inner ring 3 and the outer ring 4, and after the loading is completed, the guide part 21 is attached to a side portion on the second side in the axial direction of the outer ring 4.

As a result, even if the raceway grooves 6 are not formed on the inner ring 3 and the outer ring 4, the multiple ball rows 5 can appropriately be interposed between the inner ring 3 and the outer ring 4 while being restricted from moving in the axial direction to the outside of the inner ring 3 and the outer ring 4.

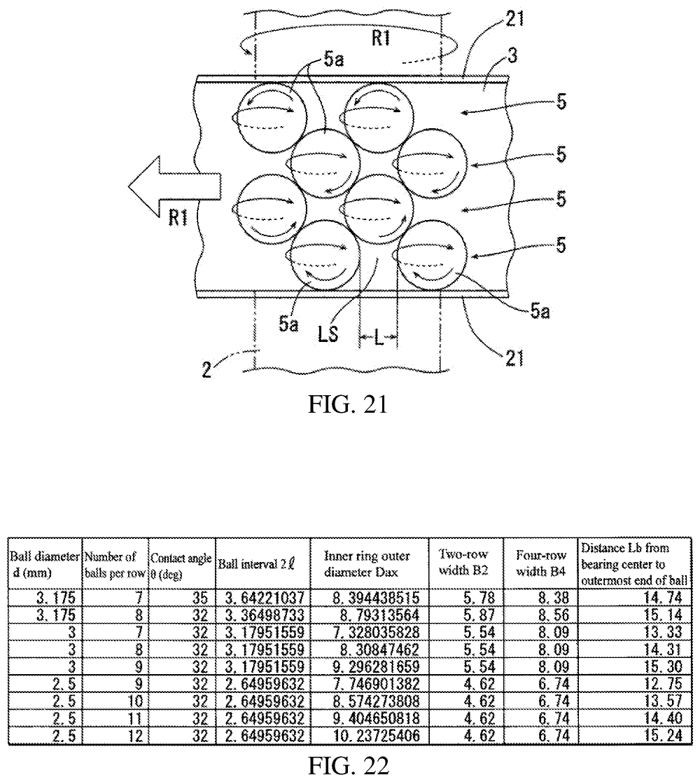

8. FIGS. 20 and 21 illustrate a fifth embodiment. The fifth embodiment illustrates a modification of the fourth embodiment and, in the fifth embodiment, the same constituent elements as those of the fourth embodiment are denoted by the same reference numerals and will not be described.

In the fifth embodiment, the outer circumferential surface of the inner ring 3 is provided with the attachment grooves 22 formed over the entire circumferences on both sides in the width direction (both sides in the axial direction), and expandable/contactable rings such as so-called C rings are used as the guide parts 21, so that the guide parts 21 are made to engage with the attachment grooves 22 by using the expandable/contactable properties thereof. Accordingly, also in the fifth embodiment, even if the raceway grooves 6 are not formed on the inner ring 3 or the outer ring 4, the multiple ball rows 5 can appropriately be interposed between the inner ring 3 and the outer ring 4 while being restricted from moving in the axial direction to the outside of the inner ring 3 and the outer ring 4.

Additionally, in this multirow ball bearing 1, the balls 5a in the left and right outer ball rows 5Lo, 5Ro are each bought into contact with the guide part 21 while rotating (in such fashion that the z axis rotation component is maintained), and the balls 5a in the left and right outer ball rows 5Lo, 5Ro face the same side as the movement direction of the inner ring 3 at the contact portions with the guide parts 21 of the inner ring 3 although not exactly in the same direction (see the rotation direction of the rotation component about the z axis in FIG. 20), so that the direction is not completely opposite to the movement direction of the inner ring 3. Therefore, even if the guide parts 21 are disposed on the inner ring 3, the frictional force can be reduced at the contact portions between the guide part 21 and the balls 5a in the left and right outer ball rows 5Lo, 5Ro.

### WORKING EXAMPLES

9. FIG. 22 illustrates dimensions and so forth of elements in the multirow ball bearing 1 as a specific structure. The contact angle θ, a ball 5a gap 21, a two-row width B2, and a four-row width B4 in FIG. 22 are as depicted in FIG. 12, and a distance Lb from the center of the multirow ball bearing 1 to the outermost end of the ball 5a and an outer diameter Dax of the inner ring 3 are as depicted in FIG. 2.

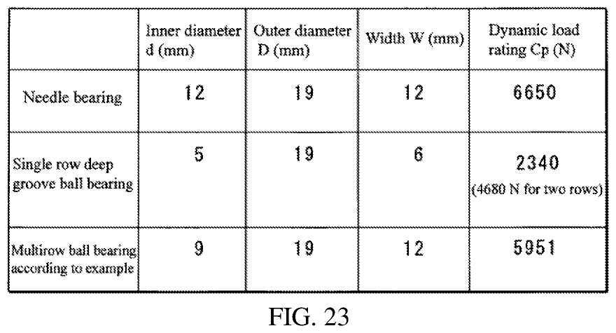

10. FIG. 23 illustrates basic dynamic load ratings of various bearings.

According to FIG. 23, although unable to attain levels of values of a needle bearing in terms of the basic dynamic load rating, the multirow ball bearing 1 according to the working example achieved values considerably exceeding those of a double row deep groove ball bearing derived from a single row deep groove ball bearing. It is thought that this is a result of effective dispersion of radial load which is made possible when the multirow ball bearing 1 according to the working example bears the radial load with multiple balls 5a of the multiple ball rows 5 and restricts the free rolling movement of the balls 5a.

11. Any of the embodiments of the present invention described above may include any of the following aspects.

(1) An aspect related to how guide parts 21 are disposed which may be implemented by causing the guide parts 21 to be alternately disposed on the outer side portion on a first side in the axial direction of the outer ring 4 and the outer side portion on a second side opposite the first side in the axial direction of the inner ring 3.

(2) The number of ball rows of the multirow ball bearing 1 can be appropriately selected.

(3) When the multirow ball bearing 1A is used, a support shaft may be attached to the inner ring 3, and the outer ring 4 side may be rotationally driven.

### EXPLANATION OF REFERENCE NUMERALS

1 Multirow ball bearing
3 Inner ring
4 Outer ring
5 Ball row
5a Ball
5Lo Left outer ball row
5Ro Right outer ball row
5Li Left inner ball row
5Ri Right inner ball row
5M Central row
6 Raceway groove
10 Jig
12 First opening of outer ring
13 Second opening of outer ring
21 Guide part (restricting part)
22 Attachment groove
L Prescribed gap
LS Space formed by prescribed gap
Fo, Fi Revolution driving force

What is claimed is:

1. A multirow ball bearing defining a bearing axial direction, a bearing radial direction, and a bearing circumferential direction, and further defining a bearing width direction parallel to the bearing axial direction and demarcating two ends in the axial direction of the multirow ball bearing, the multirow ball bearing comprising:
an inner ring;
an outer ring arranged toward an exterior in the radial direction from the inner ring;
first and second rows of balls interposed between the inner ring and the outer ring, the first and second rows being respectively arranged in outwardmost fashion at either of the ends in the bearing width direction; and
at least one third row of balls interposed between the inner ring and the outer ring, the at least one third row being arranged so as to be inward in the bearing width direction from the first and second rows;
wherein the balls in each of the rows are arranged with gaps therebetween in the circumferential direction;
wherein the rows of balls include at least one pair of rows that are mutually adjacent in the bearing width direction;
wherein the mutually adjacent rows are arranged in staggered fashion such that a first ball in a first of the pair of mutually adjacent rows is brought into contact with a second ball and a third ball in a second of the pair of mutually adjacent rows so that the first ball faces a first space formed by a first gap which, among the gaps between the balls arranged in the circumferential direction, is formed between the second ball and the third ball;
wherein a total number of rows of balls in the first row of balls, the second row of balls, and the at least one third row of balls is an even number not less than four; and
wherein diameters of balls in a first next-to-outwardmost row of balls among the at least one third row of balls and adjacent to the first row of balls are less than diameters of balls in the first row of balls.

2. A multirow ball bearing defining a bearing axial direction, a bearing radial direction, and a bearing circumferential direction, and further defining a bearing width direction parallel to the bearing axial direction and demarcating two ends in the axial direction of the multirow ball bearing, the multirow ball bearing comprising:
an inner ring;
an outer ring arranged toward an exterior in the radial direction from the inner ring;
first and second rows of balls interposed between the inner ring and the outer ring, the first and second rows being respectively arranged in outwardmost fashion at either of the ends in the bearing width direction; and
at least one third row of balls interposed between the inner ring and the outer ring, the at least one third row being arranged so as to be inward in the bearing width direction from the first and second rows;
wherein the balls in each of the rows are arranged with gaps therebetween in the circumferential direction;
wherein the rows of balls include at least one pair of rows that are mutually adjacent in the bearing width direction;
wherein the mutually adjacent rows are arranged in staggered fashion such that a first ball in a first of the pair of mutually adjacent rows is brought into contact with a second ball and a third ball in a second of the pair of mutually adjacent rows so that the first ball faces a first space formed by a first gap which, among the gaps between the balls arranged in the circumferential direction, is formed between the second ball and the third ball;
wherein a total number of rows of balls in the first row of balls, the second row of balls, and the at least one third row of balls is an odd number not less than three; and
wherein a first contact resistance of a fourth ball in a first next-to-outwardmost row of balls among the at least one third row of balls and adjacent to the first row of balls with respect to a fifth ball in the first row of balls is different from a second contact resistance of a sixth ball in a second next-to-outwardmost row of balls among the at least one third row of balls and adjacent to the second row of balls with respect to a seventh ball in the second row of balls, the first and the second next-to-outwardmost rows of balls being a same row of balls when the total number of rows of balls is three, and the first and the second next-to-outwardmost rows of balls being respectively different rows of balls when the total number of rows of balls is not less than five.

3. The multirow ball bearing according to claim 1, wherein
at least one raceway groove for engagement with at least a portion of the rows of balls is respectively formed on at least one of an outer circumferential surface of the inner ring and an inner circumferential surface of the outer ring.

4. The multirow ball bearing according to claim 1, wherein
outer side portions in an axial direction of at least one of the inner ring and the outer ring are provided with restricting parts for restricting the multiple ball rows from moving in the axial direction toward the outside of the inner ring and the outer ring on both sides in the axial direction of the inner ring and the outer ring.

5. The multirow ball bearing according to claim 4, wherein
the restricting parts are disposed on at least one of both outer side portions in the axial direction of the inner ring and both outer side portions in the axial direction of the outer ring.

6. A method of manufacturing a multirow ball bearing including multiple ball rows interposed between an inner ring and an outer ring, the outer ring being disposed on an outer circumferential side of the inner ring, such that the ball rows are adjacent to each other in an axial direction of the inner ring and the outer ring, the method comprising:
preparing as the outer ring a ring provided with multiple raceway grooves formed adjacently in the axial direction of the outer ring on an inner circumferential surface of the outer ring, and a rod-shaped jig enabled to enter the inside of the outer ring;
first, inserting the jig from a first opening of the outer ring into the outer ring to form a guide path for the raceway groove closest to the first opening of the outer ring with an inserted tip end surface of the jig, and supplying the balls from a second opening of the outer ring into the outer ring to perform a ball loading operation of loading multiple balls into the raceway groove closest to the first opening of the outer ring;
subsequently, advancing the jig into the outer ring toward the second opening of the outer ring to sequentially form guide paths for the raceway grooves closer to the second opening of the outer ring than the raceway groove closest to the first opening of the outer ring, and performing the ball loading operation in each of the raceway grooves by using each of the guide paths each time the guide path is formed, so as to bring the balls in each of the raceway grooves into contact with balls adjacently arranged with gaps therebetween in a row direction in the raceway grooves adjacent to the raceway groove in a straddling manner between the adjacently arranged balls;
subsequently, after the ball loading operation for the raceway groove closest to the second opening of the outer ring is completed, bringing a first end surface to a first side in the axial direction of the inner ring into contact with the tip end surface of the jig; and
subsequently, moving the jig and the inner ring toward the first opening of the outer ring while maintaining a contacting relationship between the tip end surface of the jig and the first end surface of the inner ring so as to achieve a state in which an outer circumferential surface of the inner ring faces an inner circumferential surface of the outer ring.

7. The multirow ball bearing according to claim 1, wherein elastic modulus of the balls in the first next-to-outwardmost row of balls is less than elastic modulus of the balls in the first row of balls.
